(19) United States
(12) Patent Application Publication
(10) Pub. No.: US 2024/0245071 A1
(43) Pub. Date: Jul. 25, 2024

(54) SUGAR REDUCED CEREAL EXTRACT

(71) Applicant: SOCIETE DES PRODUITS NESTLE S.A., Vevey (CH)

(72) Inventors: VISHIST KUMAR JAIN, Singapore (SG); HOOI KHIM TEOH, Singapore (SG); STEFAN WALTER HAAS, Essertines-sur-Yverdon (CH); KELVIN YONG, Singapore (SG)

(21) Appl. No.: 18/565,653

(22) PCT Filed: Mar. 18, 2022
(86) PCT No.: PCT/EP2022/057208

§ 371 Date: Nov. 30, 2023

(30) Foreign Application Priority Data
Jun. 1, 2021 (EP) 21177074.8

(51) Int. Cl. A23G 1/40; A23G 1/36; A23G 1/46; A23G 1/48; A23G 1/56; A23L 2/38; A23L 2/60; A23L 7/25

(52) U.S. Cl. CPC A23G 1/40; A23G 1/36; A23G 1/46; A23G 1/48; A23G 1/56; A23L 2/382; A23L 2/60; A23L 7/25

(57) ABSTRACT

The present invention relates to a method for producing a cocoa and/or malt beverage product comprising: a) suspending cereal in an aqueous liquid to produce a mash; b) suspending adjunct in an aqueous liquid to produce a slurry; c) hydrolysing the slurries of steps a) with hydrolytic enzymes and b) with alpha-amylase; d) optionally adding transglucosidase to the mash and allowing the transglucosidase to react; c) inactivating the hydrolytic enzymes for example alpha amylase and the optional transglucosidase by increasing the temperature of the mash to a temperature above 90° C. and below 98° C. preferably above 92° C. and below 97° C. more preferably to 95° C.; f) passing the mash from step e) through a filter press to separate spent cereal grain and obtain a wort; g) combining the wort from step f) with hydrolysed adjunct slurry from step b); h) evaporating the mixed wort to high total solids to make a syrup liquid; i) combining the high total solids syrup obtained in step h) with non-fat milk solids, cocoa solids, sucrose, vegetable oil and/or milk fat to obtain a cocoa and/or malt beverage powder.

### FIELD OF THE INVENTION

The present invention relates to a method of producing a cereal beverage product, in particular a cocoa and/or malt beverage product. The invention also relates to a beverage powder obtained with the method and a liquid beverage product.

### BACKGROUND

Many food products traditionally comprise high amounts of sugar, which is important to achieve the sweet taste and texture the consumers expect of the product. For health reasons it is desired to reduce the amount of sugar in malt extract which is one of the main ingredients of cocoa malt or malt beverages. Furthermore it is also desired to replace high sugar malt extract with low sugar malt extract without significantly effecting the taste when malt extract is applied in products.

Currently there are no existing solution to control sugar creation in malt extract production e.g. by inactivation of enzymes. There are possible long-term developments such as finding new alpha amylases that are inactive at certain temperatures and times.

Solutions may be present from the equipment side of the production such as installing a heat exchanger to heat up strong wort to inactivate the enzyme or direct steam injection (DSI) at the contact point between strong wort and adjunct hydrolysate. However, such solutions are not available at present.

There is therefore a need for a method for producing a cereal based beverage product with reduced sugar. There is also a need for sugar reduced beverage powders and sugar reduced liquid beverage products.

### SUMMARY OF THE INVENTION

In a first aspect, the invention relates to a method of producing a cocoa and/or malt beverage product comprising:
a) suspending cereal in an aqueous liquid to produce a mash;
b) suspending adjunct in an aqueous liquid to produce a slurry;
c) hydrolysing the slurries of steps a) with hydrolytic enzymes and b) with alpha-amylase;
d) optionally adding transglucosidase and allowing the transglucosidase to react;
e) inactivating the hydrolytic enzymes for example alpha amylase and the optional transglucosidase by increasing the temperature of the mash to a temperature above 90° C. and below 98° C., preferably above 92° ° C. and below 97° C., more preferably to 95° C.;
f) passing the mash from step e) through a filter press to separate spent cereal grain and obtain a wort;
g) combining the wort from step f) with hydrolyzed adjunct slurry from step b);
h) evaporating the mixed wort to high total solids to make a syrup liquid; and
i) combining the high total solids syrup obtained in step h) with non-fat milk solids, cocoa solids, sucrose, vegetable oil and/or milk fat to obtain a cocoa and/or malt beverage powder.

In another aspect, the invention relates to a cocoa and/or malt beverage powder obtained with the method according to the invention, the powder comprising: 10-35% by weight of non-fat milk solids; 0-15% by weight of cocoa solids; 6-20% by weight of vegetable oil and/or milk fat; 0-25% by weight of sucrose; and 10-65% by weight of hydrolysed barley solids.

In a further aspect, the invention relates to a liquid cocoa and/or malt beverage product obtained with a method according to the invention, the liquid comprising: 3-10% by weight of non-fat milk solids; 0-5% by weight of cocoa solids; 0.3-5% by weight of vegetable oil and/or milk fat; 0-5% by weight of sucrose; and 1-6% by weight of hydrolysed barley solids.

Without wishing to be bound by theory, according to the invention it has been found that sugar generation in the presence of alpha amylase and starch is only possible if there is suitable substrate for this enzyme. The substrate present in barley stream (longer oligosaccharides) is not as preferable to this alpha amylase to generate sugar compared to substrate present in tapioca stream (presumably smaller oligosaccharides). It was observed that when barley stream (without alpha amylase inactivation) combines with tapioca stream and remain in contact for elongated time of hydrolysis this leads to rapid increase in sugar as the substrates present in tapioca stream is amicable for this alpha amylase to generate sugar. Contrary to this the prior art teaches that indeed elongated time of hydrolysis of starch in the presence of alpha amylase can generate sugar, notwithstanding, the present invention has shown that it is possible to reduce sugar generation in barley/malt production.

According to the invention with process halted at correct time, sugar generation can be controlled. It has been found that if the combined barley and tapioca hydrolysate can immediately proceed to evaporation without any hold up this can lead to very high sugar reduction.

### DETAILED DESCRIPTION OF THE INVENTION

The invention relates to a method of producing a cocoa and/or malt beverage product comprising:
a) suspending cereal in an aqueous liquid to produce a mash;
b) suspending adjunct in an aqueous liquid to produce a slurry;
c) hydrolysing the slurries of steps a) with hydrolytic enzymes and b) with alpha-amylase;
d) optionally adding transglucosidase and allowing the transglucosidase to react;
e) inactivating the hydrolytic enzymes for example alpha amylase and the optional transglucosidase by increasing the temperature of the mash to a temperature above 90° ° C. and below 98° C., preferably above 92° C. and below 97° C., more preferably to 95° C.;
f) passing the mash from step e) through a filter press to separate spent cereal grain and obtain a wort;
g) combining the wort from step f) with hydrolyzed adjunct slurry from step b);
h) evaporating the mixed wort to high total solids to make a syrupy liquid; and
i) combining the high total solids syrup obtained in step h) with non-fat milk solids, cocoa solids, sucrose, vegetable oil and/or milk fat to obtain a cocoa and/or malt beverage powder.

Enzymes used in the present invention are preferably Ondea Pro M and Transglucosidase. Ondea Pro M from Novozymes consists of alpha amylase and other auxiliary enzymes. Transglucosidase uses maltose and convert it to longer chain carbohydrate thus helping in sugar reduction.

It is preferred that the enzyme in step c) is a hydrolytic enzyme selected from the group consisting of alpha-amylase, cellulase, xylanase, beta-glucanase, pullulanase, proteinase and/or lipase, or a combination thereof.

According to the invention, the inactivating the hydrolytic enzymes for example alpha amylase and transglucosidase is done by increasing the temperature of the mash to a temperature above 90° C. and below 98° C., preferably above 92° C. and below 97° C., more preferably to 95° C. In the most preferred embodiment of the invention the temperature of the mash is increased to 95° C. which means that the temperature of the mash is 95° C. or passing though 95° C. to a higher temperature. The temperature can for example be advantageously be 95° ° C.-97° C.

Sugar composition of green barley hydrolysate, adjunct hydrolysate and malt extract with or without sugar reduction according to the invention at 80.5% TS is shown in Table 1.

TABLE 1

| | Sugar range (%) | Sugar range (%) | Sugar reduction | Sugar reduction |
|---|---|---|---|---|
| | in malt extract | in malt extract | (%) extract | (%) extract |
| | (without | (with | (without | (with |
| Stream | transglucosidase) | transglucosidase) | transglucosidase) | transglucosidase |
| Cereal extract | 28-34 | 18-24 | — | — |
| Adjunct extract | 4-10 | 4-10 | — | — |
| Malt extract | 13-19 | 9-15 | 26-49 | 41-64 |

Table 1 shows the range of sugar (%) of different streams at 80.5% TS. For sugar reduction (%) calculation, ref sugar was taken as 26 g/100 g for factory protomalt extract. The sugar values in malt extract does not include hold-up time and weak wort contribution.

TABLE 2

| | Total | Sugar reduction |
|---|---|---|
| | sugar | wrt to factory |
| Sample | (%) | protomalt |
| With transglucosidase immediate inactivation | 11.54 | 55.6 |
| (malt extract) (34767.089) | | |
| Without transglucosidase immediate inactivation | 15.5 | 40.4 |
| (malt extract) (34767.090) | | |

Table 2 shows the sugar profile of malt extract with and without transglucosidase. Cereal stream was immediately inactivated after completion of brewing and then combined with the adjunct stream. The combined stream immediately proceeded for evaporation to produce malt extract. For sugar reduction (%) calculation, ref sugar was taken as 26 g/100 g for factory malt extract.

The sugar reduction data in table 1 shows that the present invention may lead to around 50%-60% sugar reduction from current malt extract reference sugar (26 g/100 g). However, in factory set-up, the sugar reduction % never reached to this extent. In the factory set-up, the combination of barley stream and adjunct stream may remain in hold-up for several hours (max 8 h) before the commencement of evaporation. This delay significantly influences the final sugar profile of the sugar reduced malt extract due to thermotolerant alpha amylase in barley stream which keep on hydrolysing oligosaccharides in adjunct hydrolysate during hold-up and increases approximately ˜1 g-2 g sugar/h in malt extract.

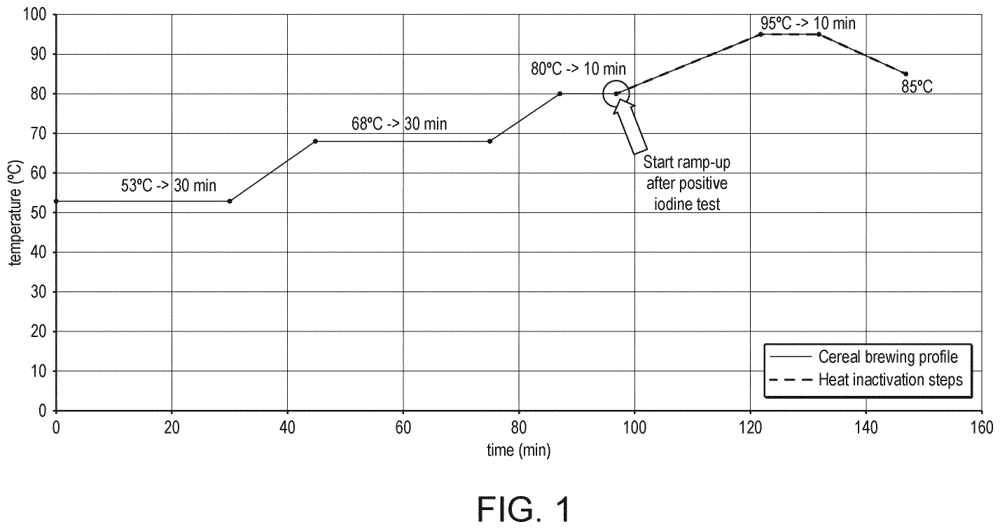

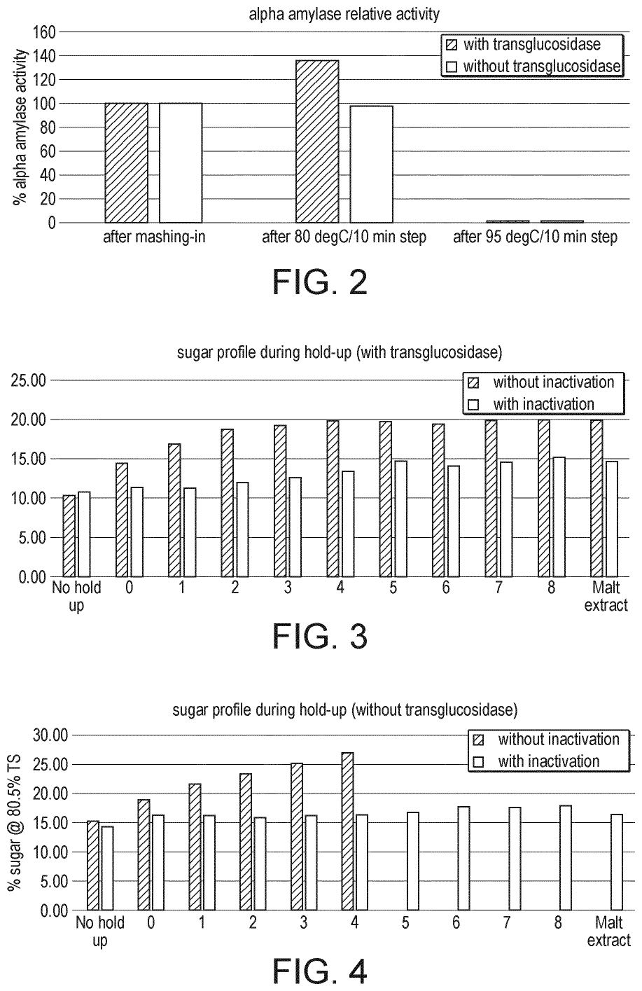

To tackle this issue, alpha amylase was inactivated by increasing the temperature of the mash to 95° C. and rest at this temperature for 10 min. FIG. 1 describes the normal brewing profile and then ramping up to 95° C. for 10 min. Mash samples collected at three different stages of mashing for enzyme activity, namely i) just after mashing-in, ii) after 80° C./10 min step and iii) after 95° C./10 min. Alpha amylase activity of the first sample was assigned as a 100% activity and the next two samples activity was relative to the first sample. FIG. 2 shows the results for alpha amylase enzymatic activity of the mash samples collected at different stages of mashing.

As the enzyme activity data suggests, 80° C. heat treatment for 10 min does not lead to any decrease in alpha amylase activity whereas the activity almost becomes negligible after 95° ° C. heat treatment for 10 min. To subsequently investigate the effect of complete loss of enzyme activity on sugar profile, trials were carried out where mash (sugar reduced recipe and Ref recipe) was heated at elevated temperature (95° C./10 min) after completion of brewing and then combined with adjunct hydrolysate. The combined stream was then hold-up for 0 h-8 h and samples were withdrawn on hourly basis for sugar analysis and then extrapolated to 80.5% TS. Strong wort and adjunct hydrolysate samples were also withdrawn for sugar analysis. The sugar data for sugar reduced recipe with and without inactivation is shown in FIG. 3 and sugar data for cereal ref. recipe with and without inactivation is shown in FIG. 4.

The data suggests that the rate of sugar increase is higher when the enzyme is not inactivated compared to when enzyme is inactivated. Without enzyme inactivation for the sugar reduced recipe, there is around 10 g sugar increase in the first 5 h itself after which sugar increase is minimal. Similarly, for cereal Ref recipe, there is also around 10 g sugar increase within 4 h (sugar data only till 4 h hold up). The rate of sugar increase decreases sharply when the enzyme is inactivated at 95° C. for 10 min with only around 3 g sugar increase over 8 h for both sugar reduced recipe and cereal Ref recipe. Sugar reduction for reduced sugar recipe and Ref recipe was around 43% and 36% respectively compared to reference (Ref) malt extract.

A further trial was carried out with heat inactivation, but the combined stream of barley and adjunct immediately proceeded for evaporation after completion of leaching process. Table 2 shows the sugar profile and sugar reduction % for sugar reduced recipe and green barley Ref recipe with enzyme inactivation and immediate evaporation of combined adjunct and barley stream. The data shows that even higher sugar reduction can be achieved with enzyme inactivation and with enzyme inactivation and without hold-up of the combined stream.

By transglucosidase is understood one or more enzymes with enzymatic activity of enzyme class EC 3.2.1.20, also called alpha-glucosidase, which catalyses the hydrolysis of terminal, non-reducing (1->4)-linked alpha-D-glucose residues with release of alpha-D-glucose. A transglucosidase according to the invention may have only transglucosidase activity or may additionally possess one or more side activities. Especially, a transglucosidase of the invention may have activity of enzyme class EC 2.4.1.24 and catalyse the transfer of an alpha-D-glucosyl residue in a (1->4)-alpha-D-glucan to the primary hydroxy group of glucose, free or combined in a (1->4)-alpha-D-glucan, e.g. producing isomaltose from D-glucose, and panose from maltose. In a preferred embodiment of the invention, a transglucosidase has activity of both enzyme class EC 3.2.1.20 and enzyme class EC 2.4.1.24.

By alpha-amylase is understood one or more enzymes with enzymatic activity of enzyme class EC 3.2.1.1, which catalyses the endohydrolysis of (1->4)-alpha-D-glucosidic linkages in polysaccharides containing three or more (1->4)-alpha-linked D-glucose units. An alpha-amylase according to the invention may have only alpha-amylase activity or may additionally possess one or more side activities.

EC (Enzyme Committee) numbers refer to the definition of enzymatic activity and nomenclature given by the Nomenclature Committee of the International Union of Biochemistry and Molecular Biology as in force on 26 Aug. 2019.

Cocoa and/or Malt Beverage Products

In one embodiment, the present invention relates to cocoa and/or malt beverage products. By cocoa and/or malt beverage products are meant cocoa and/or malt beverages in liquid form, which can be consumed directly; or cocoa and/or malt beverage powders, which can be used to prepare a cocoa and/or malt beverage by suspension in an aqueous liquid, such as e.g. water or milk. The cocoa and/or malt beverage products of the invention comprises non-fat milk solids, cocoa solids, vegetable oil and/or milk fat, and hydrolysed barley solids.

Non-fat milk solids may be derived from any suitable milk source, such as e.g. liquid milk, e.g. skim milk and/or whole milk, and/or milk powder, e.g. skim milk powder and/or whole milk powder. If liquid milk is used, it may be concentrated, e.g. by evaporation or filtration.

By hydrolysed barley is meant barley that has been subjected to enzymatic hydrolysis by carbohydrate degrading enzymes, e.g. alpha-amylase. The hydrolysis may be performed by the use of purified enzymes and/or enzyme preparations, or it may be performed using the endogenous enzymes of barley malt, e.g. as in a conventional mashing process, or it may be a combination of using endogenous and added enzymes. Enzyme preparations to be used may e.g. comprise alpha-amylase, cellulase, xylanase, beta-glucanase, pullulanase, proteinase and/or lipase. An example of a suitable commercially available enzyme preparation is Ondea Pro M from Novozymes A/S, Denmark.

Cocoa solids may be from any suitable cocoa source, e.g. in the form of cocoa powder, cocoa mass and/or cocoa butter. Vegetable oil may be any suitable vegetable oil, preferably palm oil. Milk fat may be derived from any suitable milk source, such as e.g. liquid milk or cream, e.g. skim milk, cream, and/or whole milk, and/or milk powder, e.g. skim milk powder, cream powder, and/or whole milk powder, and/or may be in the form of butter, butter oil and/or anhydrous milk fat. If liquid milk or cream is used, it may be concentrated, e.g. by evaporation or filtration.

A cocoa and/or malt beverage powder of the invention may comprise sucrose. In a preferred embodiment, a cocoa and/or malt beverage product of the invention does not comprise sucrose. In another preferred embodiment, a cocoa and/or malt beverage powder of the invention comprises 1-25% by weight of sucrose, more preferably 5-20% by weight of sucrose.

A cocoa and/or malt beverage powder of the invention may comprise any other suitable ingredients known in the art, such as e.g. vitamins, minerals, buffer salts, emulsifiers and stabilizers.

A cocoa and/or malt beverage powder of the invention may be produced by any suitable method known in the art. The ingredients may e.g. be in powder form and mixed in the dry state, some or all ingredients may be mixed in aqueous solution/suspension and subsequently dried to a powder, or some or all powdered ingredients may e.g. be co-agglomerated to produce a powder with improved solubility.

Cocoa and/or Malt Beverage Powder

In one embodiment, the cocoa and/or malt beverage product of the invention is a cocoa and/or malt beverage powder comprising: 10-35% by weight of non-fat milk solids; 0-15% by weight of cocoa solids; 6-20% by weight of vegetable oil and/or milk fat; 0-25% by weight of sucrose; and 10-65% by weight of hydrolysed barley solids; and wherein the total amount of maltose is between 1% and 8% by weight, and the total amount of isomaltose, isomaltotriose and panose is between 2% and 10% by weight.

In a preferred embodiment, a cocoa and/or malt beverage powder of the invention comprises 10-50% by weight of hydrolysed barley solids, more preferably 10-40% by weight of hydrolysed barley solids, and even more preferably 15-30% by weight of hydrolysed barley solids.

A cocoa and/or malt beverage powder of the invention may comprise sucrose. Due to the amounts of glucose and isomaltooligosaccharides present in the product, the amount of sucrose may be reduced as compared to a conventional cocoa and/or malt beverage powder while retaining an acceptable taste, sweetness and texture. In a preferred embodiment, a cocoa and/or malt beverage product of the invention does not comprise sucrose. In another preferred embodiment, a cocoa and/or malt beverage powder of the invention comprises 1-25% by weight of sucrose, more preferably 5-20% by weight of sucrose.

In a preferred embodiment, a cocoa and/or malt beverage powder of the invention comprises between 3% and 7% by weight of maltose. In another preferred embodiment, a cocoa and/or malt beverage powder of the invention comprises between 2% and 8% by weight of isomaltose, isomaltotriose and panose.

In a preferred embodiment of the cocoa and/or malt beverage powder according to the invention the combined amount of glucose, sucrose, fructose, maltose and isomaltose is between 10-40%, preferably 20-40% by weight.

In a further preferred embodiment, the invention relates to a cocoa and/or malt beverage powder comprising: 10-35% by weight of non-fat milk solids; 0-15% by weight of cocoa solids; 6-20% by weight of vegetable oil and/or milk fat; 5-20% by weight of sucrose; and 10-40% by weight of hydrolysed barley solids; and wherein the total amount of maltose is between 3% and 7% by weight, and the total amount of isomaltose, isomaltotriose and panose is between 2% and 8% by weight.

Liquid Cocoa and/or Malt Beverage Product

In one embodiment, the cocoa and/or malt beverage product of the invention is a liquid cocoa and/or malt beverage product comprising: 3-10% by weight of non-fat milk solids; 0-5% by weight of cocoa solids; 0.3-5% by weight of vegetable oil and/or milk fat; 0-5% by weight of sucrose; and 1-6% by weight of hydrolysed barley solids; and wherein the total amount of maltose is between 0.05% and 0.7% by weight, and the total amount of isomaltose, isomaltotriose and panose is between 0.1% and 1% by weight.

In a preferred embodiment, a liquid cocoa and/or malt beverage product of the invention comprises 1-5% by weight of hydrolysed barley solids, more preferably 1-4% by weight of hydrolysed barley solids, and even more preferably 1.5-3% by weight of hydrolysed barley solids.

A liquid cocoa and/or malt beverage product of the invention may comprise sucrose. Due to the amounts of glucose and isomaltooligosaccharides present in the product, the amount of sucrose may be reduced as compared to a conventional liquid cocoa and/or malt beverage product while retaining an acceptable taste, sweetness and texture. In a preferred embodiment, a liquid cocoa and/or malt beverage product of the invention does not comprise sucrose. In another preferred embodiment, a liquid cocoa and/or malt beverage product of the invention comprises 1-5% by weight of sucrose, more preferably 2-4% by weight of sucrose.

In a preferred embodiment, a liquid cocoa and/or malt beverage product of the invention comprises between 0.1% and 0.5% by weight of maltose. In another preferred embodiment, a liquid cocoa and/or malt beverage product of the invention comprises between 0.1% and 0.8% by weight of isomaltose, isomaltotriose and panose.

In a preferred embodiment of the liquid cocoa and/or malt beverage product according to the invention the combined amount of glucose, sucrose, fructose, maltose and isomaltose is between 1% and 3.5% by weight.

In a further preferred embodiment, the invention relates to a liquid cocoa and/or malt beverage product comprising: 3-10% by weight of non-fat milk solids; 0-5% by weight of cocoa solids; 0.3-5% by weight of vegetable oil and/or milk fat; 0-5% by weight of sucrose; and 1-4% by weight of hydrolysed barley solids; and wherein the total amount of maltose is between 0.1% and 0.5% by weight, and the total amount of isomaltose, isomaltotriose and panose is between 0.1% and 0.8% by weight.

### Method

In one embodiment, the invention relates to a method of producing a cocoa and/or malt beverage product of the invention. The method comprises the following steps:

Barley to be used in the method of the invention may e.g. be in the form of green barley and/or barley malt. The green barley or barley malt may be treated in any suitable way to facilitate the hydrolysis, usually it will be crushed or ground to increase the surface area and facilitate the access of the alpha-amylase to the substrate. The barley to be hydrolysed may be combined with one or more adjuncts such as e.g. starches of tapioca, cassava, maize or rice, the slurry to be hydrolysed by alpha-amylase may e.g. comprise 30-70% by dry weight of adjunct, e.g. 30-70% of tapioca starch.

Preferably, in the method according to the invention the cereal is selected from the group consisting of green barley, oats, barley, corn, rice, wheat, maize, rye, sorghum, triticale, sesame, quinoa, buckwheat, spelt, amaranth, pearl millet, or a combination thereof. More preferably the cereal is green barley.

Furthermore, preferably in the method according to the invention the adjunct is selected from the group consisting of tapioca, oats, barley, corn, rice, wheat, maize, rye, sorghum, triticale, sesame, quinoa, buckwheat, spelt, amaranth, and pearl millet or a combination thereof, the adjunct preferably being tapioca.

The mash of barley is hydrolysed with alpha-amylase. The hydrolysis of the barley mash may be performed by adding alpha-amylase to the mash, e.g. in the form of pure alpha-amylase or in the form of an enzyme preparation comprising alpha-amylase. It may also be performed by using barley malt for the mash. Barley malt contains endogenous alpha-amylase, as well as other carbohydrate degrading enzymes, which is allowed to react with carbohydrates of the barley malt in the mash. The purpose of the hydrolysis is to transform starch contained in the barley into lower molecular carbohydrates and sugars, such as e.g. glucose, fructose, maltose and maltotriose.

If alpha-amylase is added as an enzyme preparation, the enzyme preparation may comprise further enzyme activities, e.g. cellulase, xylanase, beta-glucanase, pullulanase, proteinase and/or lipase. The pH of the barley may be adjusted before the contacting with an enzyme preparation comprising alpha-amylase, the pH may e.g. be lowered, e.g. to a pH in the range of pH 4.8-5.1. pH adjustment may be performed in any suitable way, e.g. by addition of a base, e.g. sodium hydroxide, and/or calcium chloride. In a preferred embodiment of the method of the invention the calcium is added to decrease the pH.

Barley malt is barley grain that has undergone a germination step wherein endogenous enzymes, including alpha-amylase, have been formed. These enzymes are able to degrade high molecular weight substances such as starch, protein and fat into low molecular substances such as sugars, mainly comprising glucose, fructose, maltose and maltotriose, amino acids and fatty acids. If barley malt is used, it may be treated in any suitable way to induce the hydrolysis. Hydrolysis of barley malt, also known as “mashing” is a well-known process e.g. used in brewing and production of malt extract.

A transglucosidase is optionally added to the barley mash in aqueous liquid to produce isomaltooligosaccharides and glucose. Any suitable transglucosidase may be used such as e.g. a transglucosidase from Aspergillus niger such as e.g. Transglucosidase L “Amano” (Amano Enzyme Inc., Japan). The addition may be performed at any suitable temperature and for any suitable time, taking the characteristics of the transglucosidase into consideration. The addition to the mash of transglucosidase may be performed before, during and/or after hydrolysing the mash with alpha-amylase. In a preferred embodiment, the addition of transglucosidase to the mash is performed after starting hydrolysis with alpha-amylase. In a preferred embodiment, the addition of transglucosidase is performed 10-60 minutes after the start of the hydrolysis with alpha-amylase. Adding transglucosidase later in the process helps to accumulate maltose thereby promoting transferase activity to make isomaltooligosaccharides.

The temperature of the mash may be changed between the start of the hydrolysis with alpha-amylase and the addition of transglucosidase. In a preferred embodiment, the temperature of the mash is increased by 5-30° C. after the start of the hydrolysis with alpha-amylase before the addition of transglucosidase.

After the hydrolysis with alpha-amylase and the reaction with the optional transglucosidase has progressed to the desired degree, the enzymatic reactions is stopped, e.g. by inactivating the enzymes. In a preferred embodiment, the temperature of the mash is increased to between 70° C. and 95° C. after the addition of transglucosidase to inactivate the enzymes.

In one embodiment, the hydrolysis with alpha-amylase is started before the addition of transglucosidase and the temperature of the mash during the hydrolysis with alpha-amylase before the addition of transglucosidase is between 45 and 60° C.

Spent grain is removed from the mash to produce a wort. The spent grain may be removed by any suitable method, e.g. by filtration or centrifugation. The spent grain may be removed before or after adding tranglucosidase, i.e. the transglucosidase reaction may be performed while the spent ground is present and/or after it has been removed. The wort may be concentrated, e.g. by evaporation and/or filtration, and may additionally be dried, e.g. by spray drying or roller drying. Transglucosidase may be added before or after concentration. Transglucosidase may also be added after drying, in this case the dried wort is suspended in an aqueous liquid at suitable conditions for the transglucosidase to be active. This provides an alternative way to promote the transglucosidase reaction.

The wort may be combined with other ingredients before further processing, for example, the wort may be combined with hydrolysed starch, e.g. hydrolysed tapioca starch.

The wort is combined with non-fat milk solids, cocoa solids, vegetable oil and/or milk fat, and optionally sucrose and other ingredients, to obtain a cocoa and/or malt beverage product. This may be done by any methods known in the art. The ingredients may be combined in dry form or liquid form, some ingredients may be in dry form and some in liquid form. In one embodiment, the wort constitutes between 20 and 65% by weight of dry solids of the final cocoa and/or malt beverage product.

If the final product is a liquid cocoa and/or malt beverage product, the water content of the final mixture may be adjusted to achieve the final desired solids content in any suitable way, e.g. by addition of water. The product may be heat treated to improve shelf stability, e.g. by pasteurisation, UHT treatment, or sterilisation, and packed in suitable containers.

If the final product is a cocoa and/or malt beverage powder, the ingredients may e.g. be in powder form and mixed in the dry state, some or all ingredients may be mixed in aqueous solution/suspension and subsequently dried to a powder, or some or all powdered ingredients may e.g. be co-agglomerated to produce a powder with improved solubility.

The invention is further illustrated with reference to the drawings:

FIG. 1 shows a cereal brewing profile (blue line) and heat in steps (red line) according to the invention.

FIG. 2 shows alpha amylase activity of the cereal mash collected after mashing-in step, after 80° C./10 min step and after 95° C./10 min step. Alpha amylase activity was analyzed using Megazyme kit using artificial substrate.

FIG. 3 illustrates the sugar reduction effect of the method of the present invention. The figure shows sugar profile with transglucosidase at 80.5% TS during hold up of combined cereal and adjunct stream with inactivation and without inactivation of enzyme. The term “No hold up” signifies sugar profile at 80.5% TS with contribution from cereal stream and adjunct stream. For “No hold up”, the actual analyzed sugar values of cereal wort from step f) and adjunct hydrolysate from step b) before mixing was taken for calculation. The counting of time for hold-up kick starts after the whole cereal stream (after filling, filtration and leaching) combined with adjunct hydrolysate. The malt extract sugar profile is the sugar profile after evaporation of the combined stream to ˜80.5% TS.

FIG. 4 shows the sugar profile without transglucosidase at 80.5% TS during hold up of combined cereal and adjunct stream according to the invention with inactivation and without inactivation of enzyme. The term “No hold up” signifies sugar profile at 80.5% TS from cereal stream and adjunct stream. For “No hold up”, the actual analyzed sugar values of cereal wort from step f) and adjunct hydrolysate from step b) before mixing was taken for calculation. The counting of time for hold-up kick starts after the whole cereal stream (after filling, filtration and leaching) combined with adjunct hydrolysate. The malt extract sugar profile is the sugar profile after evaporation of the combined stream to ˜80.5% TS.

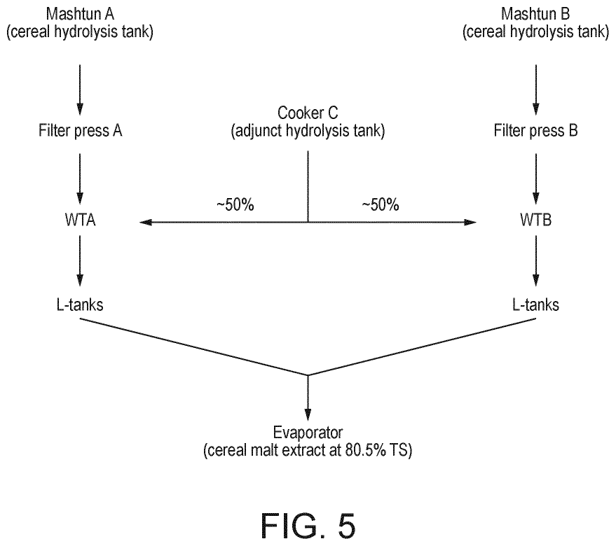

FIG. 5 shows a process flow for malt extract production according to the invention. In this process cereal and adjunct are hydrolyzed in separate vessels and later after hydrolysis are combined at the weighing tank (WT) stage before going to Liquor tanks (LT) and finally for evaporation to produce malt extract at 80.5% TS.

1. A method for producing a cocoa and/or malt beverage product comprising:
suspending cereal in an aqueous liquid to produce a mash;
suspending adjunct in an aqueous liquid to produce a slurry;
hydrolysing the slurries of steps a) with hydrolytic enzymes and b) with alpha-amylase;
inactivating the hydrolytic enzymes by increasing the temperature of the mash to a temperature above 90° C. and below 98° C.;
passing the mash through a filter press to separate spent cereal grain and obtain a wort;
combining the wort from the previous step with hydrolysed adjunct slurry from the second step;
evaporating the mixed wort to high total solids to make a syrup liquid; and
combining the obtained high total solids syrup with non-fat milk solids, cocoa solids, sucrose, vegetable oil and/or milk fat to obtain a cocoa and/or malt beverage powder.

2. Method for producing a beverage product according to claim 1, wherein the enzyme is a hydrolytic enzyme selected from the group consisting of alpha-amylase, cellulase, xylanase, beta-glucanase, pullulanase, proteinase lipase, and a combination thereof.

3. Method for producing a beverage product according to claim 1, wherein the fourth step is started 10-60 minutes after the start of the third step.

4. Method for producing a beverage product according to claim 1, wherein the temperature of the mash is increased by 5-30° C. after the start of the third step.

5. Method for producing a beverage product according to claim 1, wherein the wort obtained constitute between 20 and 65% by weight of dry solids of the final cocoa and/or malt beverage powder.

6. Method for producing a beverage product according to claim 1, wherein the cereal is selected from the group consisting of green barley, oats, barley, corn, rice, wheat, maize, rye, sorghum, triticale, sesame, quinoa, buckwheat, spelt, amaranth, pearl millet, and a combination thereof.

7. Method for producing a beverage product according to claim 6, wherein the cereal is being green barley.

8. Method for producing a beverage product according to claim 1, wherein the adjunct is selected from the group consisting of tapioca, oats, barley, corn, rice, wheat, maize, rye, sorghum, triticale, sesame, quinoa, buckwheat, spelt, amaranth, and pearl millet and a combination thereof.

9. Method for producing a beverage product according to claim 8, wherein the adjunct preferably being tapioca.

10. Method for producing a beverage product according to claim 1, wherein the mixed wort is evaporated to 70% to 90% total solids.

11. A cocoa and/or malt beverage powder, the powder comprising:
10-35% by weight of non-fat milk solids;
0-15% by weight of cocoa solids;
6-20% by weight of vegetable oil and milk fat;
0-25% by weight of sucrose;
10-65% by weight of hydrolysed barley solids; and
a combined amount of glucose, sucrose, fructose, maltose and isomaltose between 10-40%, preferably 20-40% by weight.

12. (canceled)

13. A liquid cocoa and/or malt beverage product, the liquid comprising:
3-10% by weight of non-fat milk solids;
0-5% by weight of cocoa solids;
0.3-5% by weight of vegetable oil and milk fat;
0-5% by weight of sucrose;
1-6% by weight of hydrolysed barley solids; and
a combined amount of glucose sucrose, fructose, maltose and isomaltose between 1% and 3.5% by weight.

14. (canceled)
